(19) United States
(12) Patent Application Publication
(10) Pub. No.: US 2015/0180678 A1
(43) Pub. Date: Jun. 25, 2015

(54) ACCESSING DEVICES VIA AN ELECTRONIC PROGRAM GUIDE

(71) Applicant: EchoStar Technologies L.L.C., Englewood, CO (US)

(72) Inventor: Daniel Nadeau, Cumming, GA (US)

(73) Assignee: EchoStar Technologies L.L.C., Englewood, CO (US)

(21) Appl. No.: 14/138,205

(22) Filed: Dec. 23, 2013

(51) Int. Cl. H04L 12/28; H04N 21/637; H04N 21/41; H04N 21/482; H04N 21/472

(52) U.S. Cl. CPC H04L 12/283; H04N 21/482; H04N 21/472; H04N 21/4131; H04N 21/637; H04L 2012/2849; H04L 2012/285

(57) ABSTRACT

A map that associates each device in a set of devices, and each channel of media content in a set of channels of media content, with a respective channel number in a set of channel numbers. Input is received that includes a channel number. Information is retrieved related to one of the devices according to the channel number.

### BACKGROUND

So-called home automation systems generally include devices such as sensors, cameras, and the like that provide data to a computing device such as a central controller. The central controller may then provide information relating to events, the environment, and so forth, in a building such as a home. Further, the central controller may be used to actuate and/or change settings in home automation devices, e.g., raise or lower a temperature setting in a thermostat, turn a light on or off, etc. However, user interfaces for accessing and/or controlling home automation devices may be inconvenient to use. Accordingly, there is a need for improved mechanisms for accessing and/or controlling home automation devices.

### SUMMARY OF THE DRAWINGS

FIG. 1 is a block diagram of an exemplary home automation control system.

FIG. 2 illustrates an exemplary graphical user interface in an electronic program guide.

FIG. 3 illustrates a further exemplary graphical user interface in an electronic program guide.

FIG. 4 is a diagram of an exemplary process for displaying and/or accessing device statuses and/or settings.

### DETAILED DESCRIPTION

### Introduction

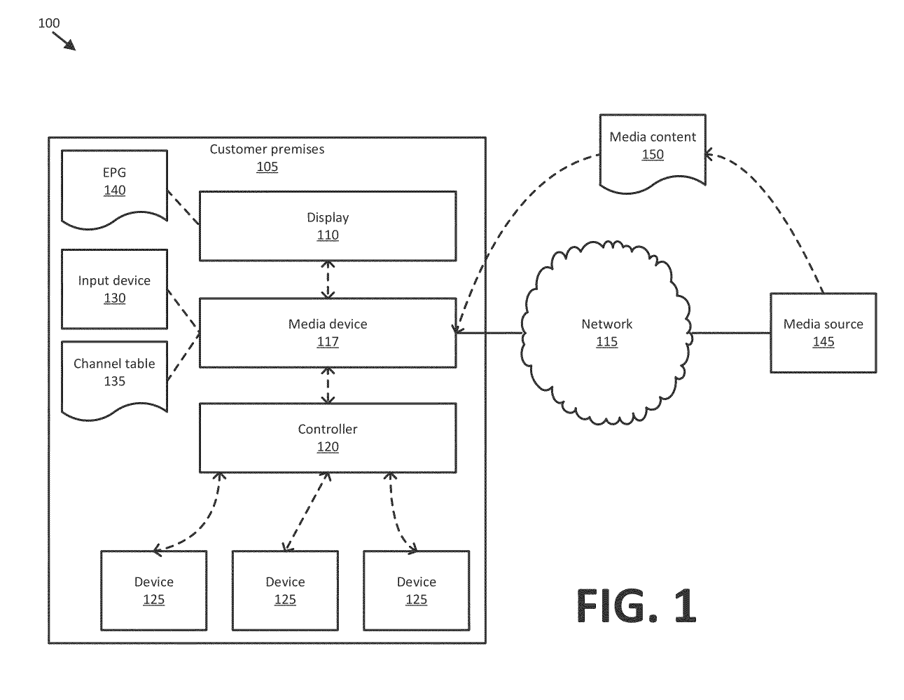

FIG. 1 is a block diagram of an exemplary home automation control system 100. As seen in FIG. 1, the system 100 generally includes a customer premises 105. The customer premises 105 may include a home automation controller 120 that receives and interprets data from, and/or controls, one or more devices 125, e.g., a light, a thermostat, a carbon monoxide detector, a smoke detector, a video or still camera, etc. The customer premises 105 may further include a media device 117, which in turn includes and/or is communicatively coupled to a media display 110. The media device 117 may be a set top box or the like configured to receive media data 150 from a media source 145 outside the customer premises 105, e.g., via a network 115. Further, the media device 117 may be configured to display the media data 150, e.g., a television program, sporting event, movie, etc., via the display 110, in addition to displaying an electronic program guide (EPG) 140.

The media device 117 may include, or, as illustrated in FIG. 1, be communicatively coupled to, the controller 120. The input device 130, e.g., a conventional remote control, may be used to select channels of media content 150 and/or to access the EPG 140. Further, using a channel table 135 that maps devices 125 to channel numbers that may be selected in the media device 117, the input device 130 and/or some other input device of the media device 117 may be used to access information from one or more devices 125, modify settings in one or more devices 125 and/or otherwise control one or more devices 125, etc.

### Exemplary System Elements

### Customer Premises

The customer premises 105 generally includes a building, structure, or portion thereof. For example, the customer premises 105 may be a house, condominium, apartment, or other home residence. Further, although the system 100 is described herein with respect to “home” automation systems, the system 100 could include, and/or systems and/or processes disclosed herein could be applicable to, commercial or other types of premises 105. Various mechanisms for communications between the devices 117, 120, 125, 130, etc. within the customer premises 105 may be utilized in the context of the system 100, and may include various networking technologies, such as infrared communications, a wired and/or wireless local area network (LAN), Bluetooth, ZigBee, Z-Wave, etc.

The display 110 may be included in the media device 117, e.g., the media device 117 could be a computing device including a screen or monitor, speakers or headphones, etc., but also the display 110 could be a device such as a television, video monitor, mobile telecommunications device, tablet, or the like. When content 150 is referred to herein as being “displayed,” it is to be understood that such display could include any possible mode of displaying media data, such as a display of visual data, audio data, etc.

The media device 117 may be a specialized device for receiving media content 150, e.g., a set-top-box (STB) or the like, and is generally a device including a computer processor and associated storage, e.g., volatile memory, nonvolatile memory, etc., and capable of communicating via the network 115. Exemplary media devices 120 include, in addition to a set-top-box, a personal computer such as a laptop, handheld, or tablet computer, a smart phone, etc. Further, as mentioned above, the media device 120 may be connected to a display device 110, e.g., a television, or may incorporate a display device 121, e.g., a display of a personal computer.

The controller 120 is generally a computing device including a processor and a memory, and also includes mechanisms for communicating with, and receiving data from, one or more devices 125. For example, the controller 120 generally may communicate with the devices 125 via known mechanisms, e.g., according to IEEE 802.11, the ZigBee protocol, the Z-Wave protocol, the Bluetooth protocol, and/or a wired local area network (LAN), etc. The controller 120 may be, or may be included in one or more various computing devices, including a laptop computer, desktop computer, dedicated home automation computer, media device 117 such as a set-top box, etc. The controller 120 may include a gateway mechanism (or a gateway could be a separate device), the gateway mechanism generally including software and/or hardware such as is known for allowing one or more computing devices, e.g., the controller 120, to communicate via a network 115.

Devices 125, as mentioned above, may include one or more sensors, cameras, etc. For example, a device 125 may be a motion sensor, noise sensor, temperature sensor, thermostat, moisture sensor, camera, carbon monoxide detector, smoke detector, etc. Further, a device 125 may be a control system or the like that is located in the customer premises 105 and configured to provide data to the controller 120, e.g., a home thermostat may communicate with the controller 120 to provide information relating to temperature settings, detected temperature. Other examples of devices 125 include lamp control modules, appliance (e.g., dishwasher, refrigerator, etc.) control modules, window shade controls, etc.

The input device 130 may be a conventional remote control or the like, such as mentioned above. Alternatively or additionally, the system 100 could include input device 134 accessing the media device 117 such as a keyboard, touchscreen, pointing device, etc.

A channel table 135 is generally maintained in a non-volatile memory of the media device 117. For example, the channel table 135 may include a list of media content 150 channel identifiers and generally also channel descriptions that may be listed in the EPG 140, where such channels of media content may be selected by a user for display according to instructions stored in the media device 117. Further, the channel table 135 may include a list of devices 125 that may be accessed by a selection of a channel identifier via the input device 130. Table 1 below provides an example of at least a portion of a channel table 135.

TABLE 1

| Channel ID | Mapping |
|---|---|
| 003 | Media content channel 3 (local TV channel 3) |
| 005 | Media content channel 5 (local TV channel 5) |
| 103 | Media content channel 103 (HBO) |
| 212 | Media content channel 212 (ESPN) |
| 307 | Media content channel 307 (CNN) |
| 701 | Outdoor lights (back) |
| 702 | Outdoor lights (front) |
| 703 | Living room lights |
| 704 | Master bedroom lights |
| 801 | Garage camera |
| 802 | Back yard camera |
| 803 | Front door camera |
| 901 | Thermostat |
| 902 | Humidity sensor |

In actual implementation, a channel table 135 would likely include many more channels of media content 150 than shown in Table 1, as well as additional channels mapped to devices 125. Further, the channel table 135 may include additional columns or fields, e.g., a unique or substantially unique identifier for a device 125, e.g., a controller device 125 for a light or set of lights, a camera device 125, a thermostat device 125, etc.

For example, a device 125 could be identified according to one or more of an identifier or address such as a network address, e.g., an Internet protocol (IP) address, a machine address, e.g., a media access control (MAC) address, a device identifier or address assigned in a home automation system by the controller 120, etc. Accordingly, the channel table 135 may be used to map a user selection of a channel in an EPG 140, or otherwise accessible via the input device 130 of the media device 117, to a device 125.

Moreover, the channel table 135 could include other information about a device 125, e.g., one or more categories or types with which a device 125 is associated. For example, as discussed below, a device 125 may be assigned to a type category (e.g., lights, thermostats, cameras, etc.), a location category (e.g., basement, main floor, top floor, garage, etc.), or some other category.

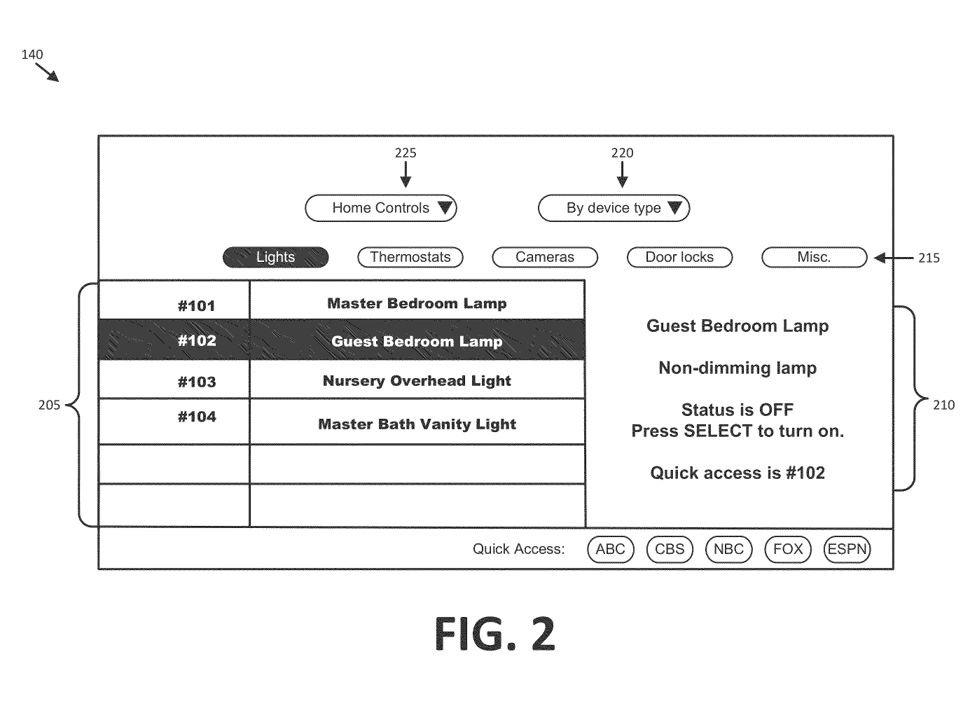

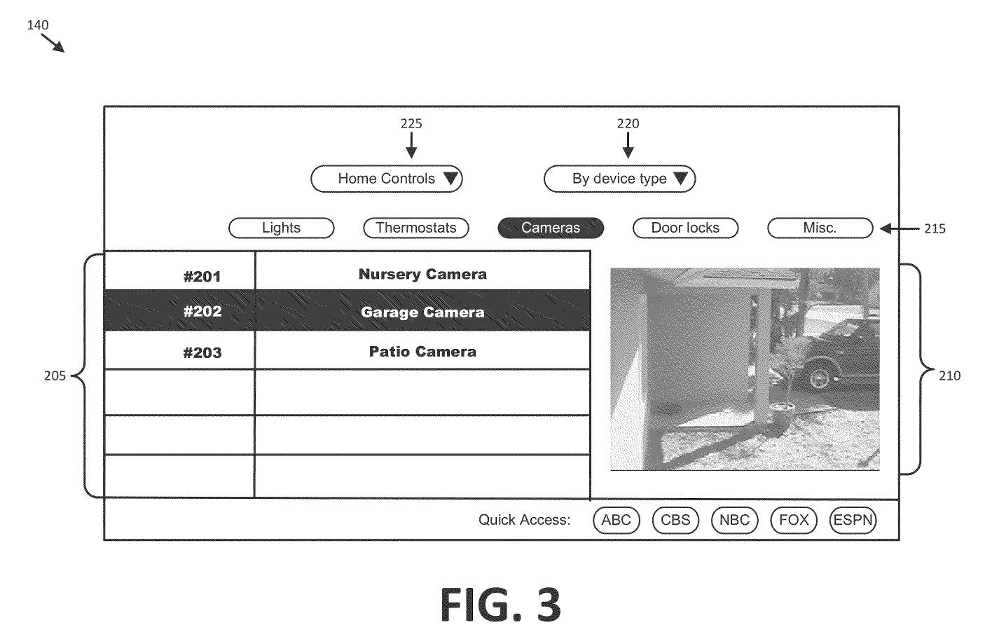

The electronic program guide 140 generally provides a user of the media device 117 with lists of channels of media content 150, and generally also descriptions of media content 150. Further, as illustrated with respect to FIGS. 2 and 3, discussed below, the EPG 140 may list devices 125 along with channel numbers or the like associated with respective devices 125. Accordingly, a user may access information provided by a device 125 and/or control the device 125 and/or modify device 125 settings via the EPG 140. Alternatively or additionally, even if the EPG 140 is not provided on the display 110, as described further below, a user may access, control, and/or modify a device 125 by providing a device 125 channel number or the like to the media device 117 via the input device 130. Note that a “channel number” as referenced herein generally includes numeric digits, but could also include alphabetic characters and/or be alpha-numeric.

### Network

In general, the network 115 represents one or more mechanisms for data to and from the customer premises 105. Accordingly, the network 115 may be one or more of various wired or wireless communication mechanisms, including any desired combination of wired (e.g., cable and fiber networks) and/or wireless (e.g., cellular network, satellite network, etc.) communication mechanisms, and any desired network topology (or topologies when multiple communication mechanisms are utilized). Exemplary communication networks include wireless communication networks, local area networks (LAN) and/or wide area networks (WAN), including the Internet, etc. The network 115 generally utilizes digital and/or packet networking technologies.

### Media Source

In general, a media source 145 may include multiple elements for processing, storing, and providing media content 150 and related data. Elements of the source 145 may be local to one another and/or may be distributed amongst multiple locations. For example, media source 145 may include computer servers and data storage devices, e.g., for storing and processing content 150 and other data such as discussed herein. By way of example and not limitation, media content 150 data may be provided as video-on-demand through a cable, satellite, or internet protocol television (IPTV) distribution system, as streaming Internet video data, or as some other kind of data. Accordingly, the media source 145 may include one or more of a cable or satellite television head-end, a video streaming service such as generally includes a multimedia web server (or some other computing device), or some other mechanism for delivering multimedia data. In general, examples of media content 150 include various types of data, including audio, video, images, etc.

Media content 150 is generally delivered via the network 115 in a digital format, e.g., as compressed audio and/or video data. The media content 150 generally includes, according to such digital format, media data 103 and content metadata 104. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 150 may be provided in a format such as the MPEG-1, MPEG-2 or the H.264/MPEG-4 Advanced Video Coating standards (AVC) (H.264 and MPEG-4 at present being consistent), or according to some other standard or standards. For example, media content 150 could be audio data formatted according to standards such as MPEG-2 Audio Layer III (MP3), Advanced Audio Coding (AAC), etc. Further, the foregoing standards generally provide for including metadata or the like in the media content 150, such as may be used by the media device 117 to populate the EPG 140.

### Exemplary Graphical User Interfaces

FIG. 2 illustrates an exemplary graphical user interface in an electronic program guide 140. In the example of FIG. 2, the EPG 140 includes a device/channel list 205 that lists some or all of the devices 125 in a customer premises 105 that may be accessed via the EPG 140. The device/channel list 205 also provides channel numbers associated with each of the respective devices 125.

A device information area 210 of the EPG 140 provides status information and the like for a selected device 125. The device information area 210 may also provide information concerning ways in which a user may modify one or more settings of the device 125. For example, as seen in FIG. 2, a “Guest Bedroom Lamp” device 125 is selected. The area 210 provides a description of the device as a “Non-Dimming Light.” The area 210 further notifies a user that a “Select” button or the like on an input device 130 may be pressed to turn the light on, thereby implicitly notifying the user that the lamp is currently in an “off” status (although such notification could be provided explicitly in the area 210 as well).

A device category list 215 lists various categories of devices 125 available for access via the EPG 140. By selecting from the device category list 215, a user may select types or categories of devices 125 to be listed in the EPG 140. For example, as seen in FIG. 2, the list 215 allows a user to make selections “By Device Type,” i.e., available device 125 categories include “Lights,” “Thermostats,” “Cameras,” “Door Locks,” and “Misc.”

A device display mode selector 220 allows a user to control a manner in which devices 125 are categorized, e.g., in the device category list 215. In the present example of FIG. 2, devices 125 are categorized according to a device 125 type. However, devices 125 could be categorized according to other criteria, e.g., a device 125 location in the customer premises 105 (e.g., basement, main floor, second floor, bedrooms, living area, kitchen, garage, etc., are examples of device 125 locations). If a device 125 location was selected by the device display mode selector 220, then the list 215 would display locations by which a device is categorized.

And EPG mode selector 225 allows a user to select a display mode of the EPG 140. For example, in FIG. 2, the selector 225 is set to display “Home Control” information. Other possible display modes that could be selected by the selector 225 include broadcast television channels, cable television channels, pay-per-view media content 150, some combination of the foregoing, etc.

FIG. 3 illustrates a further exemplary graphical user interface in an electronic program guide 140. The EPG 140 as seen in FIG. 3 is similar to that of FIG. 2, and like elements will not be re-described. As seen in FIG. 3, the device category list 215 indicates that a “Cameras” category is selected, and the device/channel list 205 lists available camera devices 125 in the customer premises 105. Further, the device information area 210 provides an image from a selected camera device 125. Moreover, the device information area 210 provides a “select to view events” option, which if selected could allow a user further options for viewing image data from the selected camera device 125. For example, the user could select a time or times for which the user would see images, could select to see a stream of moving images where the device information area 210 provides only a still image, etc.

### Exemplary Process Flow

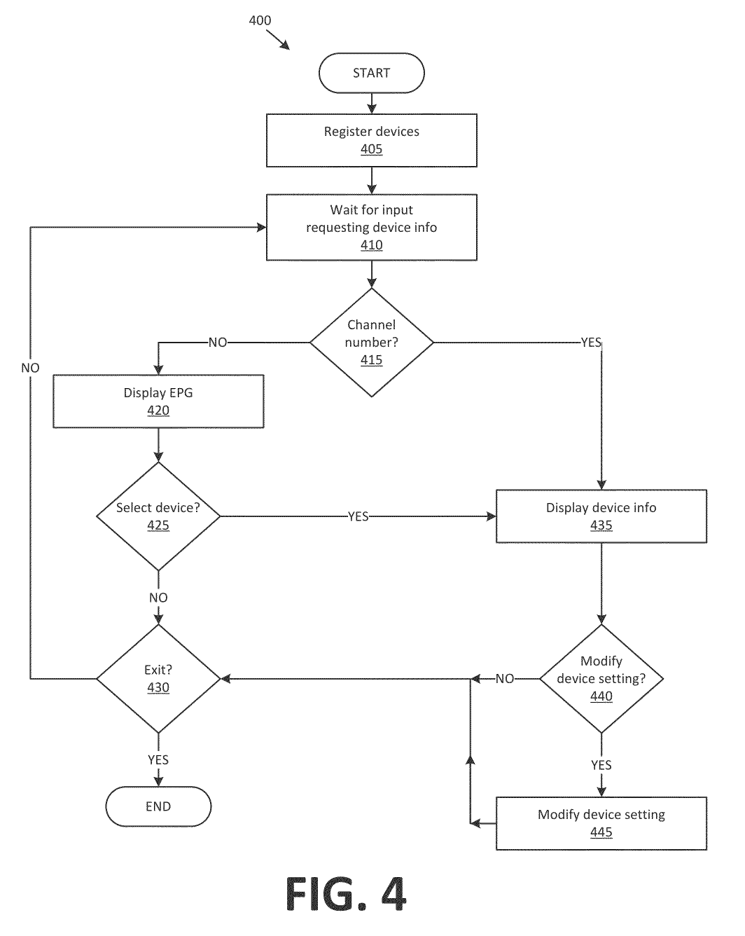

FIG. 4 is a diagram of an exemplary process 400 for displaying and/or accessing device 125 status and/or settings. The process 400 begins in a block 405, in which the media device 117 registers home automation devices 125. Generally, the registration process is undertaken once and may be updated periodically, but is not performed on every iteration of the process 400. In any event, the block 405 may include gathering data for, and populating, the channel table 135. For example, the device 117 may communicate with the controller 120 to obtain a list of devices 125 available in the customer premises 105. Such devices 125 may be included in the channel table 135 and/or a user may select devices 125 for inclusion in the channel table 125. Further, the controller 120 may provide identifying information, e.g., identifiers, addresses, etc., and other information, such as a device 125 type, location, etc., as described above, for each device 125. The media device 117 may be configured to assign channel numbers to devices 125 and/or a user may select a channel number to be assigned to a device 125.

Next, in a block 410, the media device 117 waits for user input, e.g., via the input device 130, requesting information concerning one or more devices 125. For example, a media device 117 may be powered on and may display media content 150 or the EPG 140 according to a user request, according to a last status of the media device 117, etc. A user may provide input to request information concerning one or more devices 125, e.g., could select a channel number associated with a device 125, or could select to view the EPG 140, and further select a “Home Control” option or the like with a selector 225. Alternatively or additionally, the media device 117 could be configured to automatically display EPG 140 showing information relating to devices 125 when powered on, e.g., to display an EPG 140 such as shown in FIGS. 2 and 3.

The block 415 follows the block 410 when the media device 117 identifies input requesting information concerning one or more devices 125. In the block 415, the device 117 determines whether the input is a channel number associated with a specific device 125, e.g., by referencing the channel table 135, or whether the input is requesting a display of a “home automation” or “home control” portion or the like of the EPG 140, e.g., as discussed above regarding FIGS. 2 and 3. If a specific channel number is not provided, i.e., a display of the EPG 140 relating to more than one device 125 in the customer premises 105 is requested, then a block 420 is executed next. However, if a specific channel number associated with a device 125 is requested, then a block 435 is executed next.

In the block 420, the media device 117 provides the EPG 140 via the display 110 to provide a list of some or all of the devices 125 in the customer premises 105 available for access via the media device 117. For example, as discussed above with respect to FIGS. 2 and 3, a list 205 of devices 125 and associated channel numbers may be provided, such list representing some or all of the available devices 125 in the customer premises 105, e.g., possibly categorized by device 125 type, location, etc. Further, as mentioned above, the channel table 135 could include a device 125 identifier, address, etc., according to which a device 125 may be identified by the controller 120, and whereby the controller 125 may provide access to the device 125, e.g., provide device 125 data, allow modification to settings in the device 125, etc.

Following the block 420, in a block 425, the media device 117 determines whether a device 125 has been selected to view device 125 information and/or modified device 125 settings. For example, when a user requests to access a home automation, device, etc., portion of an EPG 140, a device 125 may be selected by default, e.g., a first device 125 listed in the channel table 135. Further, a user may make selections of devices 125 by navigating to highlight a device 125 in a list 205 using keys or the like in an input device 130, or by selecting a channel number associated with a device 125. In any event, if a device 125 has been selected, then the process 400 proceeds to the block 435. Otherwise, the process 400 proceeds to the block 430.

In the block 430, which may follow any of blocks 425, 440, 445, the media device 117 determines whether to exit the process 400. For example, the media device 117 could be powered off. Further, a user interface of the media device 117, e.g., a portion of the EPG 140, could provide a user with an option to disable access to devices 125 and/or a home automation, device control, etc. portion of the EPG 140. In any event, if a determination is made to exit the process 400, then the process 400 ends following the block 430. Otherwise, the process 400 returns to the block 410 following the block 430.

The block 435 may follow the block 415 or the block 425. In either case, the block 435 is reached because a specific device 125 has been identified, e.g., by selection of a channel number associated with the device 125, or by selection of the device 125 in an interface included in the EPG 140. As mentioned above, information relating to a device 125 may be provided to the media device 117 by the controller 120, the device 125 being identified by an address, identifier, etc. Device 125 information may be provided via a variety of mechanisms, e.g., in a device information area 210 as shown in FIGS. 2 and 3, via text displayed over, or at the top or bottom of, a display of media content 150, as audio using a text to speech mechanism or the like, etc.

The block 440 follows the block 435, and is generally reached when some user input is received. In the block 440, the media device 117 determines whether the user input is to modify a device setting or some other input, e.g., to resume viewing media content 150, to see some other portion of an EPG 140, to view information relating to a different device 125, etc. In each of the cases where the user input is other than to modify a device 125 setting, the process 400 proceeds to the block 430. In these cases, assuming input does not indicate that the process 400 should end, the process 400 will then proceed from the block 430 to the block 410 in which the input can be processed, e.g., to view information relating to a different device 125, to view a different portion of an EPG 140, etc. However, if the input is to modify a device 125 setting, then the process 400 proceeds to a block 445.

In the block 445, the media device 117 instructs the controller 120 to modify a device 125 setting according to input received in the block 440. Alternatively or additionally, the media device 117 could be configured to communicate directly with a device 125, e.g., using an address or the like provided in the channel table 135. For example, a user could change a temperature setting on a thermostat, turn a light on or off, rotate a camera, turn a camera on or off, etc. Following the block 445, the process 400 proceeds to the block 430.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical, flash, or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A computing device that includes a processor and a memory, the device being configured to:
store a map that associates each device in a set of devices, and each channel of media content in a set of channels of media content, with a respective channel number in a set of channel numbers;
receive input that includes a channel number specified in the map without displaying the channel number; and
retrieve information related to one of the devices according to the association in the map of the one of the devices with the inputted channel number.

2. The computing device of claim 1, further configured to provide the information to a display.

3. The computing device of claim 1, further configured to provide an electronic program guide to a display, the electronic program guide identifying at least two devices in the set of devices.

4. The computing device of claim 1, further configured to provide media content to a display.

5. The computing device of claim 1, wherein the set of devices includes at least one of a thermostat, a camera, a smoke detector, a carbon monoxide detector, a humidity sensor, a temperature sensor, a lock device, and a light.

6. The computing device of claim 1, wherein each of the channel numbers includes at least one of alphabetic and numeric characters.

7. The computing device of claim 1, wherein the computing device is a set-top-box.

8. A computing device that includes a processor and a memory, the device being configured to:
store a map that associates each device in a set of devices, and each channel of media content in a set of channels of media content, with a respective channel number in a set of channel numbers;
provide an electronic program guide to a display, the electronic program guide identifying at least one device in the set of devices and respective channel numbers associated with each identified device in the set of devices;
receive a selection to access information from one of the identified devices according to a channel stored in the map without providing the electronic program guide to the display.

9. The computing device of claim 8, wherein the selection includes a channel number associated with the device.

10. The computing device of claim 8, further configured to provide information from the selected device to a display.

11. The computing device of claim 8, wherein the information from the selected device includes a setting of the device; the computing device being further configured to:
receive user input to modify the setting; and
transmit a message to at least one of the selected device and a home automation controller to modify the setting according to the user input.

12. The computing device of claim 8, further configured to provide media content to a display.

13. The computing device of claim 8, wherein the set of devices includes at least one of a thermostat, a camera, a smoke detector, a carbon monoxide detector, a humidity sensor, a temperature sensor, a lock device, and a light.

14. The computing device of claim 8, wherein each of the channel numbers includes at least one of alphabetic and numeric characters.

15. The computing device of claim 8, wherein the computing device is a set-top-box.

16. A method, comprising:
storing a map that associates each device in a set of devices, and each channel of media content in a set of channels of media content, with a respective channel number in a set of channel numbers;
receiving input that includes a channel number specified in the map without displaying the channel number; and
retrieving information related to one of the devices according to the association in the map of the one of the devices with the inputted channel number.

17. The method of claim 16, further comprising providing the information to a display.

18. The method of claim 16, further comprising providing an electronic program guide to a display, the electronic program guide identifying at least one device in the set of devices.

19. The method of claim 16, further comprising providing media content to a display.

20. The computing device of claim 16, wherein the set of devices includes at least one of a thermostat, a camera, a smoke detector, a carbon monoxide detector, a humidity sensor, a temperature sensor, a lock device, and a light.
